(19) United States
(12) Patent Application Publication
(10) Pub. No.: US 2017/0249850 A1
(43) Pub. Date: Aug. 31, 2017

(54) AIR TRAFFIC CONTROL

(71) Applicant: NATS (SERVICES) LIMITED, London (GB)

(72) Inventors: Andy SHAND, London (GB); John DYSON, London (GB); Colin SMITH, London (GB)

(21) Appl. No.: 15/512,228

(22) PCT Filed: Sep. 16, 2015
(86) PCT No.: PCT/GB2015/052683

§ 371 Date: Mar. 17, 2017

(30) Foreign Application Priority Data
Sep. 17, 2014 (GB) 1416450.3

(51) Int. Cl. G08G 5/00; G01S 13/91

(52) U.S. Cl. CPC G08G 5/0082; G01S 13/913; G08G 5/0043

(57) ABSTRACT

An air traffic control system, for use by a controller controlling multiple aircraft on landing or takeoff on a runway, comprising a processor, an input device and a display device, in which the separation between a first aircraft and a second aircraft immediately following it on the runway is determined taking into account the type of the first aircraft and its consequent impact on the landing beams used in poor visibility.

### TECHNICAL FIELD

This invention relates to computerised systems for aiding air traffic control, and more particularly for aiding landings using landing beams typically, but not exclusively, in low visibility conditions.

### BACKGROUND ART

Our earlier patents including U.S. Pat. No. 8,401,773, U.S. Pat. No. 8,306,724, U.S. Pat. No. 8,255,147, and US2012303253 disclose various aspects of air traffic control systems, which may be used with those disclosed herein.

Air traffic control involves human staff communicating with the pilots of a plurality of planes, instructing them on routes so as to avoid close approaches that might risk collisions. The controllers are supplied with data on the position of the aircraft from radar units, and ask the pilots for information such as altitude, heading and speed. They instruct the pilots by radio to maintain their headings, alter their headings, in a predetermined fashion, or maintain or alter their altitudes (for example to climb to a certain altitude or to descend to a certain altitude) so as to maintain safe minimum separation between aircraft. They also instruct aircraft when to take off and land.

At this point it may be mentioned that air traffic control systems use an en route spacing method, in which aircraft are controlled to maintain a minimum miles-in-trail spacing requirement—see for example U.S. Pat. No. 6,393,358. Those systems are less common in crowded airspaces, for example in Europe.

On the other hand, with continual growth of air transportation, due to increasing globalised trade, it is important to maximise the throughput of aircraft (to the extent that this is compatible with safety). By way of example, in good weather, the runways at London Heathrow operate at close to 100% capacity, and aircraft land at a rate of around 40 per hour (one every 90 seconds).

Further increasing throughput with existing air traffic control systems is increasingly difficult. It is difficult for air traffic controllers to monitor the positions and headings of too many aircraft at one time on conventional equipment, and human controllers necessarily err on the side of caution in separately aircraft.

Some airports are often affected by low visibility conditions, such as fog, heavy pollution, or low cloud ceilings. Aircraft landing in such conditions adopt Low Visibility Procedures (“LVP” hereafter). In such procedures, the airport provides a guidance beam (a localiser beam or “LOC” hereafter) at the far end of the runway, to enable the aircraft to use an Instrument Landing System (“ILS” hereafter). Such landing beams have evolved since before the Second World War. They consist of two laterally spaced beam lobes, overlapping but differently modulated, directed along the runway from the far end in the direction from which the aircraft will land. When the aircraft is above or on the runway centreline (and central within the beam overlap) the levels of the two modulations are equal. As the aircraft deviates laterally to one side, one of the two modulations predominates over the other, warning the aircrew to move inwards. The beams narrow towards their source at the end of the runway, so that the overlap zone becomes smaller and the aircraft becomes more precisely aligned along the runway direction.

Originally, the beams were modulated at audio frequencies and the aircrew would align the aircraft by ear, but a modern ILS measures the modulation levels and provides a visual indication to the pilot to steer the aircraft, or control signals for an automatic pilot.

Similarly, the vertical path on landing is controlled by glide path antennas which generated inclined, similarly modulated, beams that, if followed, will guide the aircraft onto the runway without impinging on vertical obstacles.

Airports provide buildings, equipment such as stairs, and vehicles such as buses and fire engines. All of these can affect the LOC beams, for example by providing reflection paths. Additionally, local interference signals can affect the beams. Since these effects will typically affect one lobe more than the other, the point of equal beam strength will no longer lie on the runway centre line and/or the glide path line, which can throw an aircraft off course.

Accordingly, the International Civil Aviation Organization (“ICAO” hereafter) and other air traffic control bodies define geographical zones around the LOC beams. Terminology differs, but a “critical area” typically refers to an area of defined dimensions around the localiser and glide path antennas, which vehicles are forbidden to enter during ILS operations as they will cause of-of-tolerance interference, and a “sensitive area” is a wider area around the “critical area” within which parking and moving is controlled to prevent larger moving objects causing interference.

Buildings, fences and other metal structures can have an effect on the beam formation for ILS systems, as can trees (foliage, and whether wet or dry) and the water table under the surface. Some guidance on defining the areas so as to avoid interference with the beams is provided in:
CAP 670 Air Traffic Services Safety Requirements, Civil Aviation Authority, 30 Apr. 2013 Part B, Section 4: GEN 02: Technical Safeguarding of Aeronautical Radio Stations Situated at UK Aerodromes
(available here: http://www.caa.co.uk/docs/33/CAP670ISs03Amdt01.pdf).

The area is usually fixed in shape and set at a size that allows all aircraft types which normally use the airfield to be accommodated. Typically the sensitive area is set at 137 metres on either side of the runway centreline in the UK, and many other countries use 150 metres. Some diagrammatic examples are in
ICAO International Standards and Recommended Practices, Annex 10 to the Convention on International Civil Aviation—Aeronautical Telecommunications; Volume I (Radio Navigation Aids) Attachment C pages 9, 10 & 11 (Amendment version 84).

One large moving object which obviously cannot be completely excluded from the runway and the beam area is the landing aircraft itself. If it remains in the area of the runway it can distort the beams during the approach of a following aircraft. For busy runways at busy periods, it is sometimes desirable to land aircraft almost immediately after each other. However, the LOC beams cannot safely be used to guide the next aircraft until the previous aircraft has landed, and taxied away out of the sensitive area. With the introduction of the A380 (Code F aircraft size), modelling and analysis and measurements show that a larger sensitive area is required with the current ILS equipment. At Heathrow, a complex shape between 160 m and 190 m in width is used. It is not symmetrical, but is fixed in size.

Under current UK air traffic control procedures, aircraft are only given landing clearance when the landed aircraft has landed and taxied clear and the landing aircraft is 2 nautical miles (nm hereafter: 1 nm=1.852 km) from the runway threshold. By way of contrast, in good visibility conditions, where the landed aircraft need only have taxied clear of the runway, not the sensitive area. This results in a much longer spacing between aircraft in low visibility conditions—the spacing between aircraft on final approach may be around 6 nm when using LVP, as compared to 2.5 nm otherwise, leading to an airport capacity which is some 50% lower. Flight delays accumulate rapidly, leading to economic losses.

Recent years have seen the arrival of larger aircraft such as the Boeing 747-800 and the Airbus A380—known as “Super Heavy” aircraft. The A380 has a length of 73 m, a wing-span of 80 m and a height of 24 m. The Boeing 747-8 is even longer, though with a narrower wingspan and lower height. Whilst larger aircraft of themselves potentially decrease the number of flights required, busy airports tend not to reduce the number of landing slots available and measurements in the past years have shown that their size (and in particular their greater tail height) leads to greater impact on the landing beams, and it has therefore been necessary for airports to increase the size of the sensitive area to, for example, 190 metres rather than 137 metres. This increased sensitive area can in some cases also include the parallel taxiways such that even after the Super Heavy aircraft has taxied clear of the runway, protection still has to be applied to the ILS beam while the aircraft is taxing and in particular turning on parallel taxiways inside the 190 m sensitive area.

The landed aircraft therefore have to taxi further (at low speeds—typically as low as 5-20 km/h whilst turning off the runway onto an exit), which in turn leads to a longer time between landings and hence a longer spacing between landing aircraft.

An aim of the present invention is therefore to provide computerised support systems for air traffic control which allow human operators to increase the throughput of aircraft without an increase in the risk of losses of minimum permitted separation from its present very low level.

### SUMMARY OF INVENTION

The invention in various aspects is defined in the claims appended hereto, with advantages and preferred features which will be apparent from the following description and drawings.

Without limitation to the generality of the foregoing, aspects of the present invention detect the type of landed aircraft, and set a spacing for the next landing aircraft based on the type of the landed aircraft. The spacing depends on the size of the landed aircraft and is typically larger for larger landed aircraft.

In a preferred embodiment, each detected type of landed aircraft is mapped to a stored sensitive area (conveniently, types of aircraft may be grouped into classes which share the same stored sensitive area) and the stored areas are defined taking into account the static features (hangers and buildings) of the airport. As the shape of the beams changes along the runway, the spacing can also take into account the exit used by the landed aircraft.

One additional area of complexity is the emergence of new landing systems including GLS (Global Navigation Satellite System, or GNSS, Landing System), and continued use of Microwave Landing System, both of which have advantages over ILS in that they are inherently more resilient to reflected signal interference. This additional resilience has manually been exploited at London Heathrow whereby MLS equipped aircraft can be spaced 5 miles behind the preceding lander as the MLS sensitive area is smaller than the ILS area. However, the ability to dynamically adjust sensitive areas based on the preceding aircraft type and the type of landing system in use by the aircraft adds significant complexity to the Air Traffic Control (ATC) task and adds risk that incorrect spacing will inadvertently be applied, hence tools support is required for the controller to enable maximum benefit and keep the workload manageable.

Other factors, such as wind or weather conditions and the need to avoid the wake vortex of the preceding aircraft, may also impact on the in-trail separation between aircraft. In such cases, embodiments of the invention may select the larger of the different separations required.

It is envisaged that capacity in low visibility at busy airports can be increased by 25% or more over current procedures.

Embodiments of the invention will now be illustrated, by way of example only, with reference to the accompanying drawings in which:

### BRIEF DESCRIPTION OF DRAWINGS

FIG. 1 is a block diagram showing an air traffic control system for a sector of airspace in accordance with an embodiment of the invention;

FIG. 2 is a block diagram showing the elements of a tactical air traffic controller's workstation forming part of FIG. 1;

FIG. 3 is a diagram showing the configuration of the localiser beam on the runway;

FIG. 4 is a diagram showing the glidepath beam;

FIG. 5 is a diagram showing the positions of localiser sensitive areas;

FIG. 6 is a diagram showing schematically the data and routines making up a trajectory prediction module forming part of FIG. 3;

FIG. 7 is a diagram showing schematically the data and routines to be used to provide automated dynamic separation indications and landing clearance indications to Tower and Approach controllers;

FIG. 8 describes the approach Human Machine Interface (“HMI”) with dynamic separation indicators between aircraft; and

FIG. 9 shows and example of the tower Human Machine Interface for dynamic Localiser Sensitive Area.

### DESCRIPTION OF EMBODIMENTS

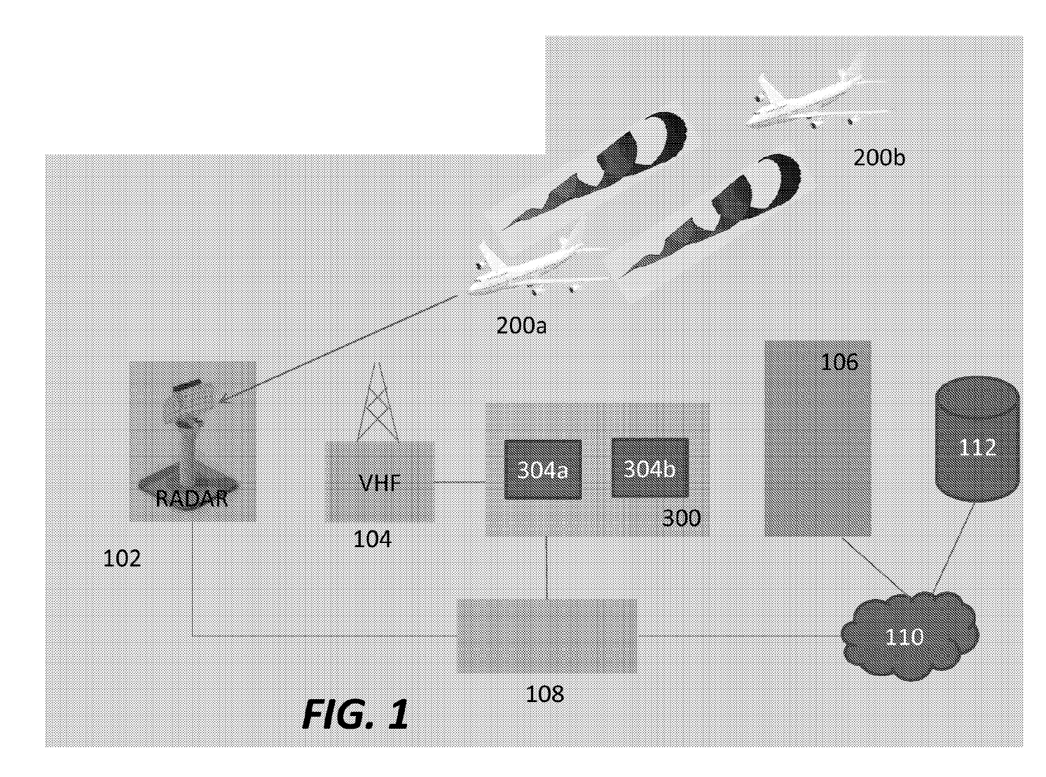

FIG. 1 shows the hardware elements of an air traffic control system (known per se, and used in the present embodiments). In FIG. 1, a radar tracking system, denoted 102, comprises a radar unit for tracking incoming aircraft, detecting bearing and range (primary radar) and altitude and identity (secondary radar), and generating output signals indicating the position of each, at periodic intervals.

A radio communications station 104 is provided for voice communications with the cockpit radio of each aircraft 200. A meteorological station 106 is provided for collecting meteorological data and outputting measurements and forecasts of wind, speed and direction, and other meteorological information.

A server computer 108 communicating with a communication network 110 collects data from the radar system 102 and (via the network 110) the meteorological station 106, and communicates with an air traffic control centre 300 (which includes an air traffic control tower). Databases (shown as 112) stores information discussed below.

The air traffic control centre 300 a plurality of work stations 304a, 304b, . . . for controllers.

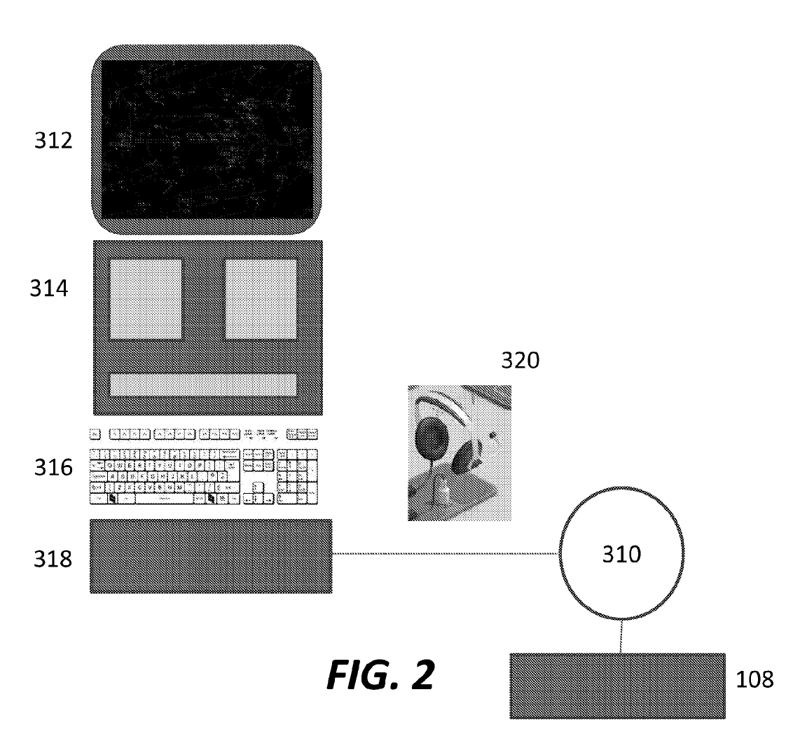

Referring to FIG. 2, each work station 304 for a controller comprises a radar display screen 312 which shows various displays a conventional radar view of the air sector, with a dynamic display of the position of each aircraft received from the radar system 102, together with an alphanumeric indicator of the flight number of the that aircraft.

A headset 320 comprising an ear piece and microphone is connected with the radio station 104 to allow the controller to communicate with each aircraft 200.

A visual display unit 314 is also provided, on which a computer workstation 318 can cause the display of one or more of a plurality of different display formats discussed below, under control of the controller operating the keyboard 316 (which is a standard QWERTY keyboard). A local area network 310 interconnects all the workstation computers 318 with the server computer 108. The server computer distributes data to the terminal workstation computers 318, and accepts data from them entered via the keyboard 316.

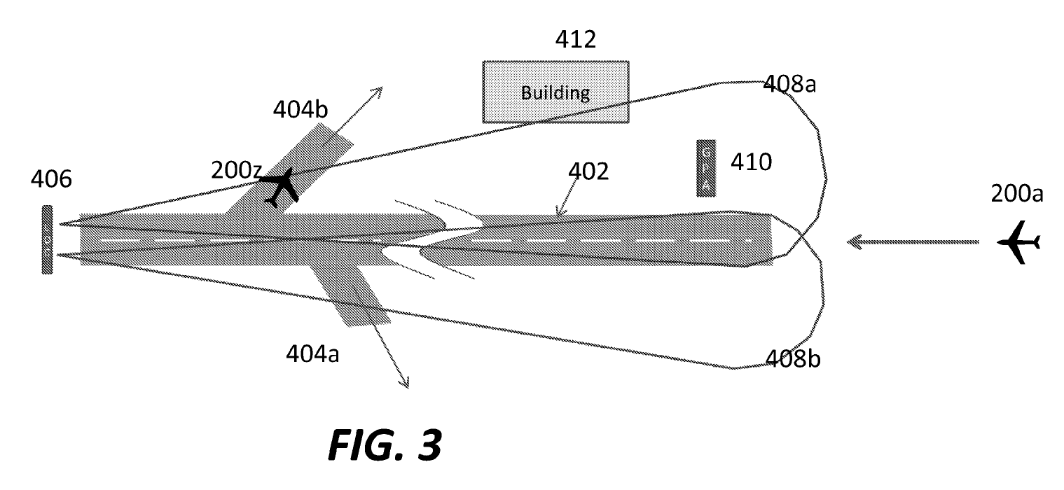

Referring to FIG. 3, a runway 402 is shown. By way of example, the two runways at London Heathrow Airport are each almost 4 km in length and about 45 m in width. On the runway 402, a landing aircraft 200a approaches from the right hand (proximal) end and lands. Having lost speed it then taxis to and turns off on one of a plurality of exit taxiways 404a, 404b, . . . .

In landing operations at a busy airport such as London Heathrow, the landing controller for the or each runway handles a stream of incoming aircraft (for example, those which have entered the area of the airport, and/or are held in stacks) awaiting clearance to commence approach. After this they are vectored to the final straight-in approach at between 10-14 nm, and then follow the localiser beam to the runway. They are indexed according to the order in which they will land, and each follows the other travelling at the same speed (typically flying 160 nm per hour as they pass a point 4 nm from touchdown) and spaced by an interval in time and in-trail space. The interval in space can be obtained from the time interval (and vice versa) using the speed relative to the ground. This, in turn, depends on the airspeed and the wind speed. Aircraft need to maintain a minimum airspeed to avoid stalling, so substantial head- or tailwind speeds can alter their speed over the ground significantly.

The controller sends speed and manoeuver instructions to the pilots, so as to space the stream of incoming aircraft such that each can land after its predecessor has cleared the runway. The aircraft 200a nearest to landing approaches the runway. If it remains safe to land, the controller instructs it to do so. In the rare case where it is not clear (for example because the previous aircraft has not cleared the runway), the controller instructs the pilot to abort the landing approach. In the meantime, the aircraft behind 200b (and those behind that 200c, 200d etc, not shown) continue to approach.

The spacing depends on a number of factors.

Firstly, as shown in FIG. 1, an aircraft 200a leaves a wake vortex behind it. The size of the vortex depends on the size of the aircraft 200a. Its effect on the following aircraft 200b depends on the size of that following aircraft 200b. In the worst case, if the aircraft 200a is large and the aircraft 200b is small, it is necessary to leave a wider spacing between the two. However, if this worst case spacing is used for all aircraft, it will limit the landing rate unnecessarily because a large aircraft 200b following a small one 200a may be substantially unaffected by wake vortex.

A larger distance spacing is required following a landing aircraft 200a which is, for example, an Airbus A380 which is in the super heavy wake vortex category, to take account of its larger wake vortex. Distance spacings are dependent on the wake vortex category of the aircraft. The applicant intends to introduce a preferred embodiment using Time Based Separation in which the spacings will be modulated to take account of the headwind component, to recover some of the lost capacity from headwind impact on speed relative to the ground. The extent of the wake vortex depends also on the aircraft airspeed. Spacing aircraft in time rather than in distance is therefore a better aid to separation on landing, because it takes account of the distance travelled through the air.

Secondly, the time taken by the landing aircraft to get off the runway is variable. The distance along the runway required to come down to taxi speed depends on the size of the aircraft, and also on weather conditions. The taxi speed is low (of the order of 10 km per hour), particularly in turning, and may also depend on weather conditions. The taxi distance required depends on which of the exit taxiways 404a, 404b, is selected. Some aircraft may be able to use any taxiway, but typically the largest aircraft can only use a subset of them. The controller is informed, by visual contact from the air traffic control tower or by communication with the pilot, when the landing aircraft is clear of the runway.

In low visibility conditions, a localiser beam (LOC) unit 406 positioned beyond the distal end of the runway 402 generates a pair of beams; a first (408a) at 150 Hz and a second (408b) at 90 Hz, with their beam patterns crossing at the centreline of the runway 402. The landing aircraft 200a can thereby align with the centreline of the runway by equalising the beam strengths. Any fixed reflecting surfaces such as building 412 or aircraft 200z have the potential to affect the integrity of the localiser beam 408a & 408b. In low visibility procedures when the integrity of the beam is required to be maintained, the landing aircraft 200a cannot be given clearance to land until the preceding aircraft 200z is clear of the localiser beam (localiser sensitive area).

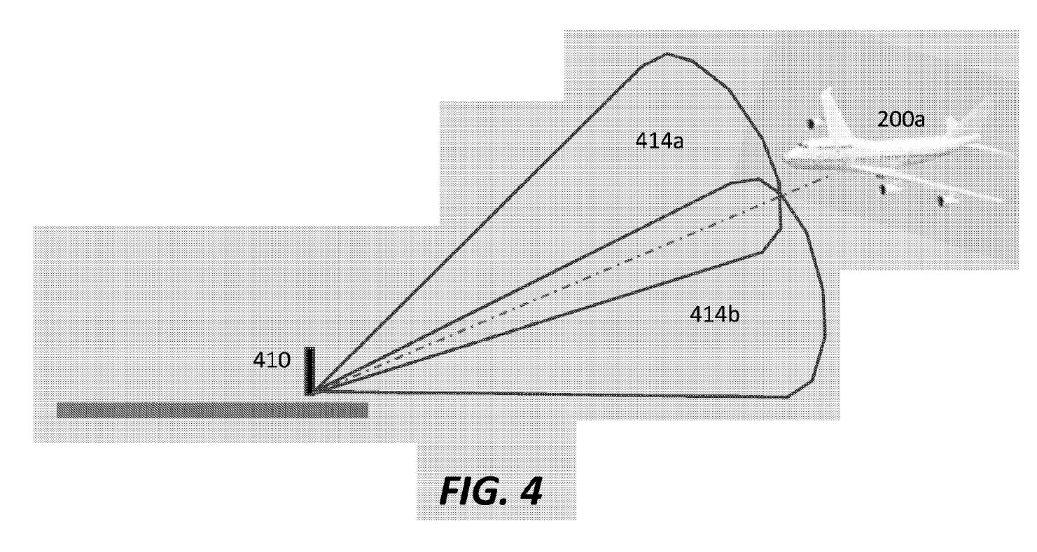

Positioned slightly to the side of the runway 402 at a point along its length is a Glide Path (aka Glide Slope) antenna unit 410. Referring to FIG. 4, the Glide Path unit 410 generates a pair of rising beams 414a, 414b a first (414a) at 90 Hz and a second (414b) at 150 Hz, with their beam patterns crossing at a line inclined at a shallow angle (for example 3 degrees) to the horizontal plane. In low visibility conditions, the landing aircraft 200a can thereby follow a glidepath to land on the runway by equalising the beam strengths.

Buildings 412 and other matter such as trees and fences surround the runway 402; some (such as emergency response buildings) close, some (such as hangers, terminals and warehouses) at a greater distance. All of these have the potential to alter the beam patterns of the LOC 406 and the GPA 410.

When low visibility conditions are predicted or observed, the ILS is switched on and controllers are informed. They then operate in a low visibility mode as described hereafter.

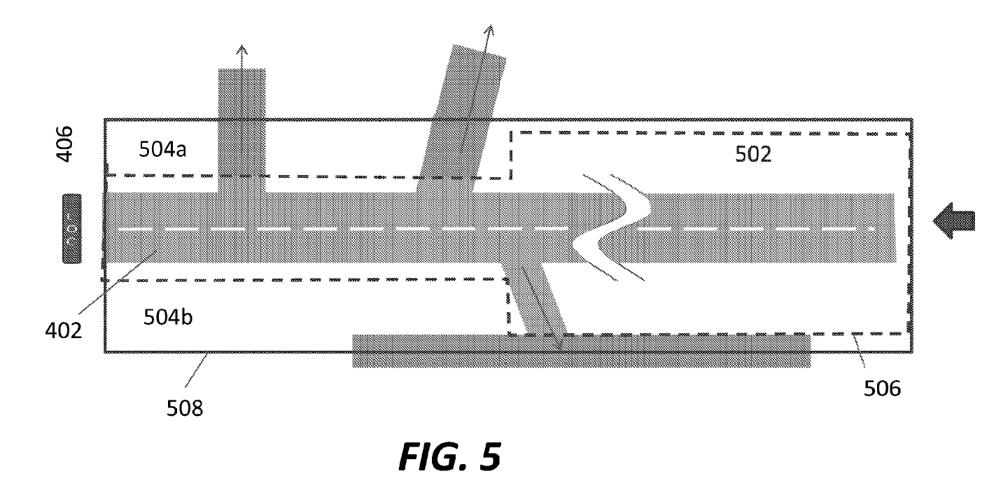

Referring to FIG. 5, a first Localiser Sensitive Area (LSA) 502 extends from the LOC 406 outwardly (with the beam pattern generated by the LOC) within a boundary around the runway defined by a box 506 (shown in dashed lines). The first LSA 502 is for smaller aircraft or, more specifically, those with lower tails (the highest part of the aircraft on the ground). A second LSA 504 defined by a boundary 508 encompasses the first and extends to either side of it in regions 504a, 504b. The second LSA 504 is applicable to larger (more specifically, taller) aircraft. Data defining the boundary 506, 508 of each respective LSA 502, 504 is stored and accessible by the computer 108 as discussed below.

Whereas only two LSAs are shown, it is understood that multiple LSAs may be defined. It may be possible to classify aircraft by the size codes A-F specified by the International Civil Aircraft Organisation (ICAO) in their “Aerodrome Design Manual”, but it is preferred to use computer modelling of the aircraft impact on the Localiser beam within groups of similar aircraft types.

The intent is that the LSA for, for example, Code C/D aircraft can be substantially reduced below the 137 m used today. For example an A320 may only need to be clear of a sensitive area of approx. 70-90 m off the runway before the next aircraft can be cleared to land, whereas a B777 may require in the order of 100 m and an A380 circa 137-150 m. At present, the A380 requires typically 190 m, but modelling according to a preferred embodiment will enable dynamic sensitive areas to be defined some of which are smaller.

Where the airport deploys a Microwave Landing System (MLS), there will likewise be an LSA around the MLS antennas (though this is smaller as the scanning beam is inherently less susceptible to interference). Likewise, use of GNSS Landing System will also allow reduced sensitive areas for the aircraft concerned.

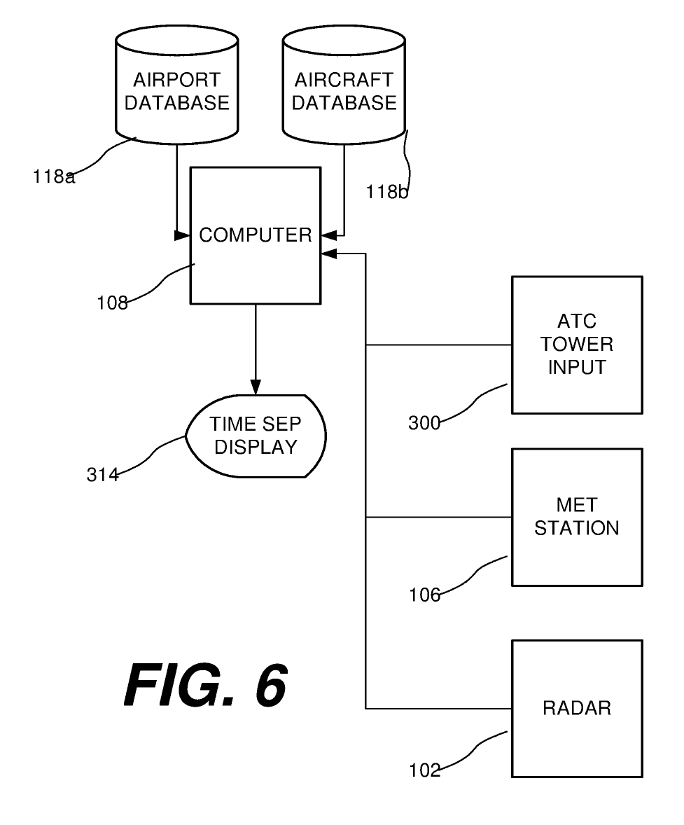

Referring to FIG. 6, the computer 108 is connected to an airport database 118a and an aircraft database 118b. The airport database stores airport-specific data including:
The length of the or each runway;
A list of runway exits for the or each runway, and for each one: data defining its path and position along the runway, a flag indicating whether it is open or closed; a flag indicating whether it is occupied or empty; and a list of which aircraft sizes it can accept;
A set of two or more LSA records for each runway, each consisting of data defining the respective boundary 506, 508, and of the aircraft size and/or type associated with that LSA based on Dynamic Sensitive Area Rules.

The aircraft database 118b stores data defining, for each unique aircraft, the model or type; the size (for example by ICAO size code), the wake vortex rules, and other data (for example whether it carries Mode S secondary radar, and/or a Microwave Landing System (MLS) or GNSS Landing System. The data may be requested from the pilot and input by the controller on first acquiring the aircraft, or (where the aircraft is supplied with Mode S radar) supplied in response to a radar interrogation. Where the Mode S signal includes a unique indentifiation of the aircraft, this can be looked up in a database listing aircraft by identifer.

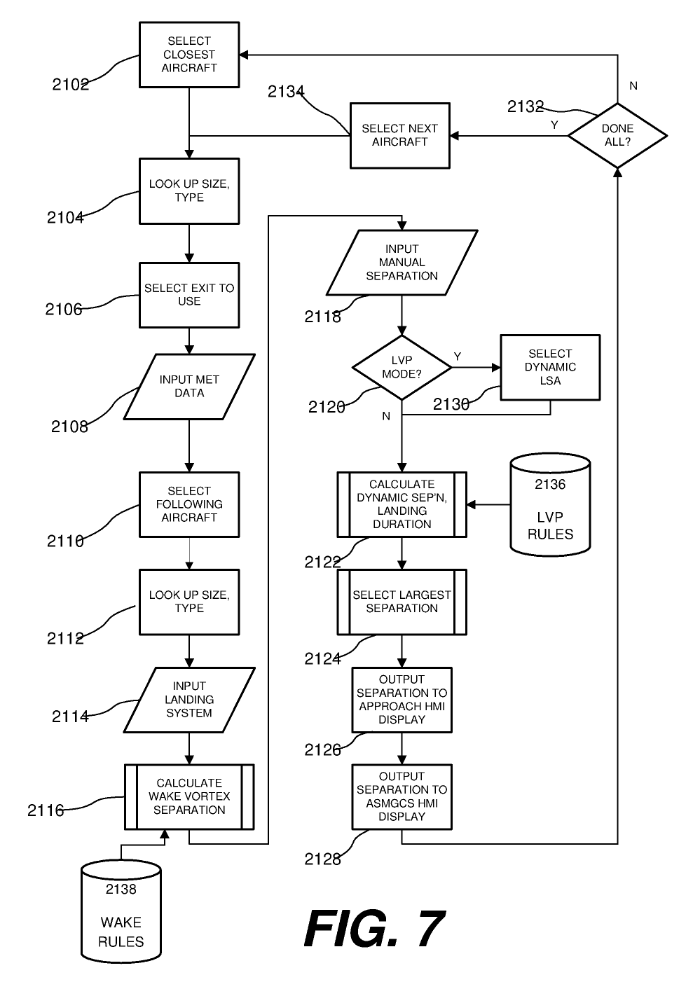

Referring to FIG. 7, the process performed by the computer 108 in the present embodiment for landing aircraft will now be described. In step 2102, the computer selects the aircraft 200a closest to landing in the list currently controlled by a controller. Radar data on each aircraft is available from the radar system 102, which provides:
Time
Aircraft position—system x, y coordinates
Mode C altitude (pressure altitude)
Mode S aircraft identification code (a unique code identifying each aircraft).
Ground velocity—ground speed and track
Altitude (climb/descent) rate—derived from Mode C altitude.

In step 2104, the computer 108 accesses the aircraft database 118a and determines the aircraft size, wake separation and other relevant data (as indicated above). In step 2106, the computer 108 accesses the airport database 118b and determines which runway exit(s) are open, available, and sized for that aircraft. It then selects for that aircraft the available runway exit closest to the point where that aircraft will land (which depends on the aircraft type and wind speed), and its braking distance (which depends on aircraft type and weather conditions—longer in rain or ice) and indicates that choice to the controller. Additionally, if the runway lighting is connected to the computer 108, it uses lighting to guide the landing aircraft 200a to the selected exit, for example illuminating the selected exit with green lights, and lighting red crosses by the other exits. The selection may in some embodiments be confirmed or overridden by the controller.

In step 2108 the computer 108 inputs meteorological data, including the wind speed and direction.

In step 2110, the computer 108 then selects the next following aircraft 200b and in step 2112 looks up the size and type in database 118a. The computer then calculates a minimum separation for the second aircraft 200b behind the first 200a to take account of the wake vortex, depending on the vortex spacing of the first 200a and the size of the second 200b, together with the wind speed and direction and the aircraft speed. The calculation may take the form of selection of one of a set of separations, one for each pair of aircraft sizes (e.g. A/A, A/B, A/F; B/A, . . . B/F; F/A, F/F).

In step 2114 the computer 108 inputs the landing system in use by aircraft 200b which will be used in 2112 to determine the Dynamic LSA to be used.

In step 2116, the computer 108 calculates the wake vortex separation to be used based on the aircraft type, meteorological conditions and rules from database 2138.

In step 2118 the computer 108, inputs any manual distance separation specified by the controller in the Air Traffic Control Tower.

In step 2120, the computer 108 determines whether LVP mode is set. If so, in step 2122, the computer 108 selects the relevant LSA based on the size of the landing aircraft 200a and the landing system in use by aircraft 200b. (e.g. if the following aircraft 200b is recorded in the database 118a as using MLS or GNSS Landing System, then a smaller LSA is instead selected (as interference with the ILS will cause it no problems). The computer also calculates the total time which the landing aircraft 200a will take to land, taxi to the relevant exit, and (in LVP mode) taxi far enough for the rear of the aircraft to leave the relevant LSA 506 or 508, is calculated. This depends on the LSA boundary, the location and path of the selected exit and also the weather conditions (ground speeds will be lower in wind, or rainy or icy conditions).

In step 2124 the computer 108 selects the largest separation time of: the time mandated to avoid wake vortex interference, the landing duration of the leading aircraft 200a (including exiting the LVP where relevant) and the LVP separation rules and any time separation input by the ATC tower, and transmits this separation, in distance and time (as noted above, the conversion is readily performed with knowledge of ground and airspeed), to the controller in step 2126 for output on the display 314 in approach.

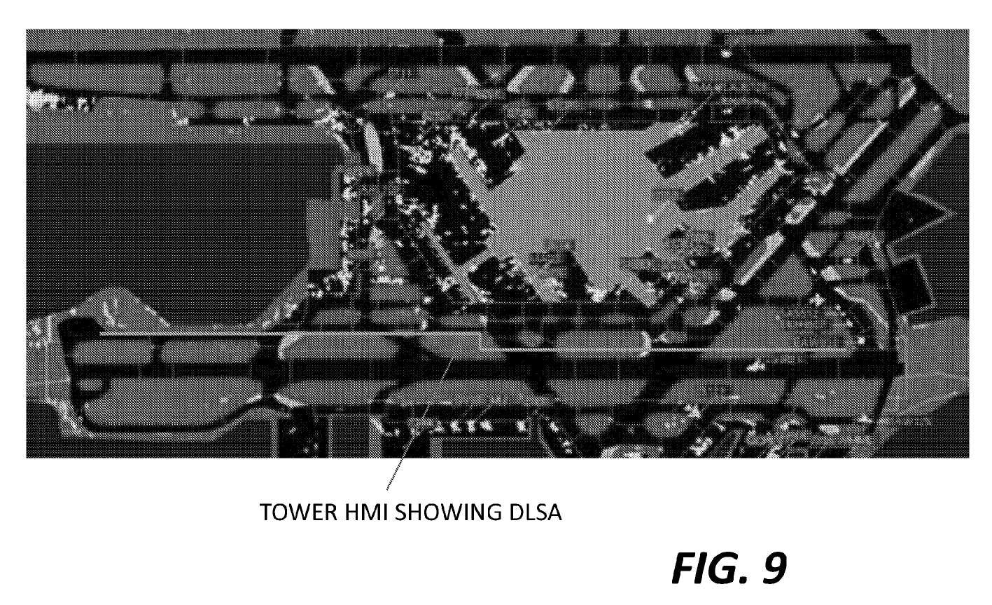

In step 2128 the computer 108 outputs the dynamic LSA to be displayed on the Tower display (HMI) (see FIG. 9).

Where the computer 108 has not yet traversed the whole incoming aircraft list, it then selects the next aircraft back in the landing stream. In this case, it is aircraft 200b. The process then repeats to determine the spacing between aircraft 200b and that which follows it (200c, not shown) in exactly the same manner as above. Thus, the computer dynamically calculates a spacing between each aircraft in the incoming landing list and the one behind it, and cyclically repeats the calculation taking account of changes in position, speed, weather and runway/exit state as the aircraft approach.

Once an aircraft 200a is detected to have landed and cleared the runway (and the LSA in LVP mode), either automatically or by manual input from the ATC staff, it is removed from the front of the list and the next-following aircraft becomes the landing aircraft 200a. Exemplary separations produced by an embodiment are as follows:

| Preceding Aircraft Type/Group | Typical Separation about: |
|---|---|
| A320/737 | 4 to 4.5 miles |
| 757/767 | 4 to 5 miles |
| 777/A340 | 4.5 to 5 miles |
| 747 | 5 to 6 miles |
| A380 | 5.5 to 6.5 miles |

Human Machine Interface

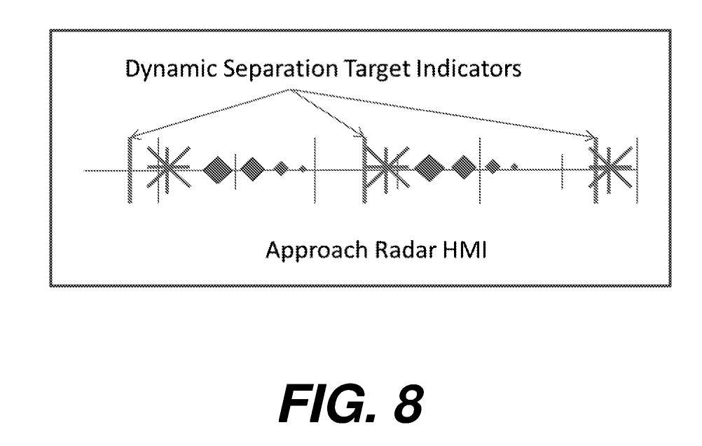

Some of the displays available on the screen 314 will now be discussed. FIG. 8 shows a Separation Monitor display comprising a horizontal axis displaying time (in seconds) between paired aircraft. A cross shows the aircraft position and the trail of diamonds indicates its path. Vertical bars traverse the approach, separated by the required time interval and governed by the position of the preceding aircraft and the separation rules that are the limiting factor (e.g. LVP or Wake), to allow the controller to vector aircraft to the correct position on final approach and where necessary instruct the pilots to alter speed to align with the bars.

FIG. 9 shows the Dynamic LSA (DLSA) screen displayed on the Tower HMI which enables the tower controller to determine when the following aircraft can be given clearance to land (i.e. the preceding aircraft must have crossed the DLSA line). The Dynamic LSA is automatically repositioned based on LVP rules by Computer 108.

Whilst the present invention has been described in connection with landing, similar principles could be employed for takeoff. For example, in a dual-use runway, where an aircraft takes off after another lands, the aircraft queued for takeoff can be positioned right at the edge of the allowable LSA associated with that aircraft, so as to minimise its taxi distance for takeoff whilst avoiding interference with the landing aircraft.

Other rules than those above (for example business-related rules concerning slots) may also be utilised. Further, the ultimate goal on the ground of each aircraft (an allocated terminal) may also be used to determine the exit to use, or the computer 108 having determined the relevant exit to minimise landing time may automatically assign a terminal and berth for each incoming aircraft, to minimise handling time.

### Other Variants and Embodiments

Although embodiments of the invention have been described above, it will be clear that many other modifications and variations could be employed without departing from the invention.

Whilst one host computer has been described, the same functions could be distributed over multiple computers.

Whilst the terminals are described as performing the human machine interface and receiving and transmitting data to the host computer, “dumb” terminals could be provided (or calculation being performed at the host). Many other modifications will be apparent to the skilled person.

1. An air traffic control system for determining separation between a plurality of aircraft (200a, 200b) taking off or landing sequentially on a runway, comprising:
a landing beam generator (410) directing at least one landing beam along a runway to guide a landing aircraft 200a, and
a processor (108) arranged to calculate a separation between the aircraft,
characterised in that:
the processor is arranged to receive an indication of the aircraft type of a first aircraft (200a), and
the processor is arranged to calculate a separation between the first aircraft (200a) and a second aircraft (200b) which will immediately follow it on the runway, based on criteria which include said aircraft type of said first aircraft.

2. A system according to claim 1, in which said runway is used alternately for takeoff and landing, and said first aircraft is landing and said second aircraft is taking off.

3. A system according to claim 1, in which said runway is used for landing, and both said first and second aircraft are landing.

4. A system according to claim 3, in which said separation is a time separation interval.

5. A system according to claim 1, further comprising:
a database (118b) storing data defining a plurality of geographical zones around said landing beam;
in which the processor is arranged to:
select one of said plurality of geographical zones in dependence on the aircraft type; and
calculate said separation based on the selected geographical zone.

6. A system according to claim 1, further comprising a receiver for receiving data allowing the determination of said aircraft type.

7. A system according to claim 1, in which said aircraft types comprise classes of aircraft according to their sizes.

8. A system according to claim 1, in which the separation is determined taking into account the type of the second aircraft.

9. A system according to claim 1, in which the landing beam is a localiser beam for guiding an aircraft in azimuth.

10. A system according to claim 1, in which the landing beam is a glide path beam for guiding an aircraft in elevation.

11. A system according to claim 1, in which the processor is arranged to the processor is arranged to receive an indication of the type of landing guidance used by said second aircraft, and to calculate said separation based also said landing guidance type.

12. A system according to claim further comprising a receiver for receiving data allowing the determination of said aircraft or landing guidance type.

13. A system according to claim 12, in which said receiver is a secondary radar receiver.

14. A system according to claim 12, in which the data indicates the identity of the aircraft.

15. A system according to claim 14, further comprising a database mapping each said identity to an aircraft type and/or landing guidance type.

16. A system according to claim 1, in which the processor is arranged to receive meteorological data, and to calculate said separation based also on said meteorological data.

17. A system according to claim 1, in which said runway has a plurality of exits, and said processor is arranged to calculate the separation based on the exit allocated to said first aircraft.

18. A system according to claim 1, in which said processor is arranged to determine the ground path of said first aircraft to minimise the separation.

19. A system according to claim 4, further comprising a display device arranged to display indications of said first and second aircraft along a time axis, and a plurality of markers spaced along said time axis indicating the calculated time separation interval therebetween.

20. A computer program, preferably stored in non-transitory form, for causing the processor of a system according to any preceding claim to function as claimed.
